(19) United States
(12) Patent Application Publication
(10) Pub. No.: US 2004/0254988 A1
(43) Pub. Date: Dec. 16, 2004

(54) Method of and universal apparatus and module for automatically managing electronic communications, such as e-mail and the like, to enable integrity assurance thereof and real-time compliance with pre-established regulatory requirements as promulgated in government and other compliance database files and information websites, and the like

(76) Inventor: Rafael A. Rodriguez, E. Taunton, MA (US)

Correspondence Address: Robert H. Rines, Rines and Rines, 81 North State Street, Concord, NH, 03301, US

(21) Appl. No.: 10/460,085

(22) Filed: Jun. 12, 2003

(51) Int. Cl. G06F 15/16

(52) U.S. Cl. 709/206; 709/207

(57) ABSTRACT

A technique and apparatus and supplemental module for providing electronic document management systems with the capability not only of ensuring the integrity and authentication of electronic communications, such as e-mail and the like, that it must receive, catalog and store, but also provide for fast, real-time compliance with pre-established and changing regulatory rules and policies, as distinguished from current post-message storage review and the inherent time delay and clogging of compliance review.

### FIELD

The invention relates to the general field of electronic communication (e-mail and the like) document management systems, wherein incoming communications are stored and later reviewed for compliance with frequently changing government and other rules and regulations; being more particularly concerned with the expediting of such compliance review through a novel automatic management technique that enables both real- time communication integrity assurance and real-time, not post storage, compliance with regulatory database files and information websites and the like.

### BACKGROUND

As above-mentioned, current electronic document management systems are struggling with assuring compliance and reporting with the growing and frequently changing regulatory rules, policies and instructions of a myriad of government agencies and in a widening circle of government and public interests, ranging from regulatory financial and trading requirements to security and safety, as examples. In addition, individual institutions and companies have promulgated their own policies and interests which are also to be followed.

Generally, as later more fully discussed, current electronic document management systems largely have post-storage review for checking compliance with a myriad of public and private regulations and for reporting on such—with the more e-mails received, for example, the longer the delays in checking and reporting compliance.

The break-through features of the present invention have now made it possible to enable real-time review for compliance and reporting, and, in addition, with assurance of the integrity of the original received e-mail or other communication.

Consider, as an example, the compliance burden on banking and insurance businesses, ranging from mere saving and storing inbound and outbound e-mail, to compliance with pre-established, but ever-changing legislative and regulatory agency regulations and requirements, including among those of the US Securities and Exchange Commission (such as Rules 17 A-3 and-4), NASD regulations (3-10 and 3-110), The New York Stock Exchange (Rules 342, 345), the US Patriot Act, and the Department of Defense (records management Rules 501-5.2), Health Insurance Portability and Accountability Act (HIPAA), Sarbanes-Oxley Act of 2002 and the UK Data Protection Act, UK Financial Services Authority (FSA), etc., to mention but a few. There are also pertinent regulatory requirements, as further examples, of the Federal Communications Commission and NASD, which assess massive fines if a company cannot provide a trail for e-mails.

The real issue, however, does not seem to reside around managing inbound and outbound e-mail, but around compliance with legislation and regulatory issues. These are all done in a fashion where the United States government maintains lots of databases and government websites which a company compliance team has to go online to monitor—whether daily or weekly—to ensure that the rules that are promulgated on a website, such as the Bureau of Export Administration, U.S. Department of Commerce's US-Denied Person's list—http://www.bxa.doc.gov/Default.htm—or the denied financial institutions list, or denied foreign entity lists, are being complied with, not only by immediate company personnel, but by the company's agents, brokers, investment bankers, accountants, lawyers—all in addition to just adequately saving the information and tracking it with its attributes.

Underlying the approach of the present invention to address this serious and growing problem, is a first concept of establishing the integrity or authenticity of the communication by creating an on-the-fly or dynamic copy of the same which, of course, cannot be altered by the ultimate destination user. The invention then proceeds to break the message up or categorize it for its content attributes, using Boolean and Neuro logic for name, date, words, subject, phrases and other defined rules for automatically storing them in a document management system database. The technique of the invention not only takes the e-mail message and stores it, but, in real time, the system goes out to all the different regulatory databases and websites to compare and verify whether or not this particular message can be sent. If it cannot be sent, the invention automatically replies to the user, whether it be an inbound user or an outbound user, that they are denied the ability to send this particular message. This is then coupled with the notion of enabling an override capability, the invention providing for the flagging together with the level of severity based on the security rules established by the company.

In short, the present invention provides the concept of an automated message integrity system (AMIS) that goes well above and beyond the notion of just simply capturing an e-mail and cataloging it. It deals, rather, with regulatory compliance and legislative issues to enable such compliance in real time—live—and the enabling of the bringing of prompt appropriate action.

### OBJECTS OF INVENTION

A principal object of the invention, accordingly, is to provide a new and improved method of and apparatus for obviating the above-mentioned delays and other problems in current electronic document management systems and the like, and that enable integrity assurance of electronic communications, and further provide for real-time compliance with pre-established regulatory requirements—particularly, though not exclusively—as such are changingly promulgated in government and other compliance database files and information websites and the like.

A further object is to provide such a novel technique and apparatus that can be universally applied to a wide variety of current and future document management systems as a supplement thereto.

Other and further objects will be hereinafter discussed and more particularly delineated in the appended claims.

### SUMMARY OF INVENTION

In summary, however, from one of its important aspects, the invention embraces a method of automatically managing electronic communications such as e-mail and the like so as to enable real-time compliance with government, industry, business, academic and/or other regulatory and other pre-established compliance requirements, the method comprising:

a) receiving the communication, sending the same to its indicated destination user, and also making a copy of the communication to ensure the integrity of the contents that was sent to the user against any user alteration of the contents;

b) categorizing the contents of the copy in terms of such elements as keywords, subject, file attachments, phrases, origination and destination;

c) accessing a compliance database file or web site information containing said government, industry, business, academic and/or other regulatory or other pre-established compliance requirement information;

d) comparing the categorized contents with such compliance requirement information in real-time;

e) in the event the comparison indicates no problems, archiving the communication copy for future recovery;

f) in the event that the comparison indicates categorized contents to be in conflict with such compliance requirement information, flagging this problem and rating its severity or importance priority; and

g) thereupon forwarding the flag and rating for compliance review.

Preferred designs and best mode implementations are hereinafter detailed.

### DRAWINGS

The invention will now be described in connection with the accompanying drawings,

FIG. 1 of which is a block diagram of a high level overview presentation of the system of the invention;

FIG. 2 is a schematic diagram of a preferred architecture of the system of FIG. 1;

FIG. 3 is similar to FIG. 2., but more detailed as to the real-time regulatory compliance features; and

FIG. 4 is a combined flow chart and schematic diagram explanatory of the invention.

### DESCRIPTION OF PREFERRED EMBODIMENTS OF INVENTION

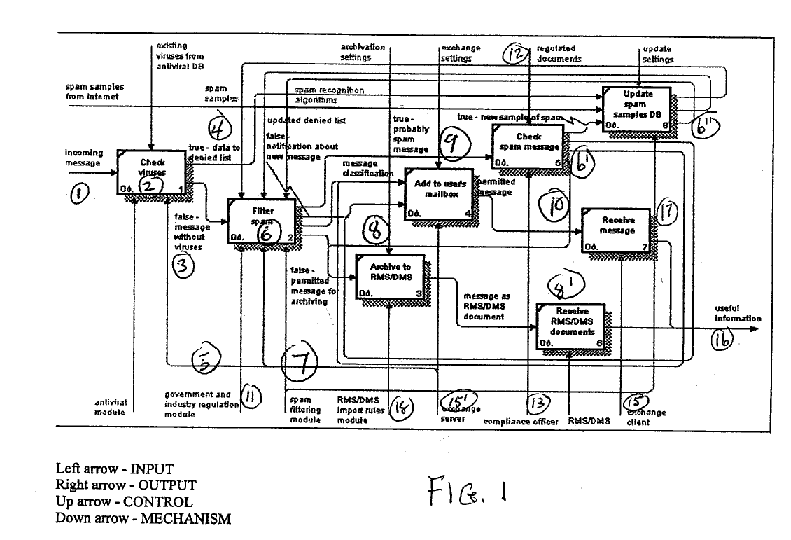

Referring to the broad overall flowchart diagram of FIG. 1, when an inbound electronic communication message, such as email or the like, comes in at 1, the message is conventionally checked for virus at 2, as by well-known programs such as that of McAfee or Norton AntiVirus or others. If the message does not contain virus, a copy will go immediately to be compared against government or company regulatory lists and information, such as, for example, denied-persons list at 4, so as to ensure that it is not sent to a financial institution with which, for example, the US Patriot Act may forbid doing business. At step 5, it is compared against such and other government and/or industry regulation modules including databases that, in the above example, are going to protect financial institutions or brokers or investment banks, etc., from communicating or doing business with forbidden foreign entities or others.

A “spam” filter 6, again of a conventional type, such as Spam.com, enables unsolicited e-mails to be routed or put into another location 7.

In accordance with the invention, as later detailed, once the incoming message has been copied, virus checked, checked against spam and other government regulatory rules, or the like, the actual message goes to the record management system (RMS) or document management system (DMS) illustrated at 8-8¹, and, for example, of the “Hummingbird” type which creates such RMS/DMS documents, or to other systems, including “Documentum”, U.S. Pat. No. 6,553,365, and “IntraSpect”—widely commercially available applications that deal specifically with document management solutions and record management solutions. Recently, such are focused on what is called the Department of Defense DOD 5015.2, specifically designed around compliance with records management.

What documents go to the RMS/DMS 8¹ are also delivered under the control of an exchange client server 15¹ to the end users mailbox 9, such as any commercially available e-mail system—for example, those known by the trademarks “Lotus Notes” and “Microsoft Exchange”. Additional components of the particular e-mail may include a return receipt check on-email to show whether or not someone has received it or mailed it, with those return messages routed again 10, as the system initiates a session on the particular application instructing it to send the message back out. This routing applies both to inbound and outbound messages.

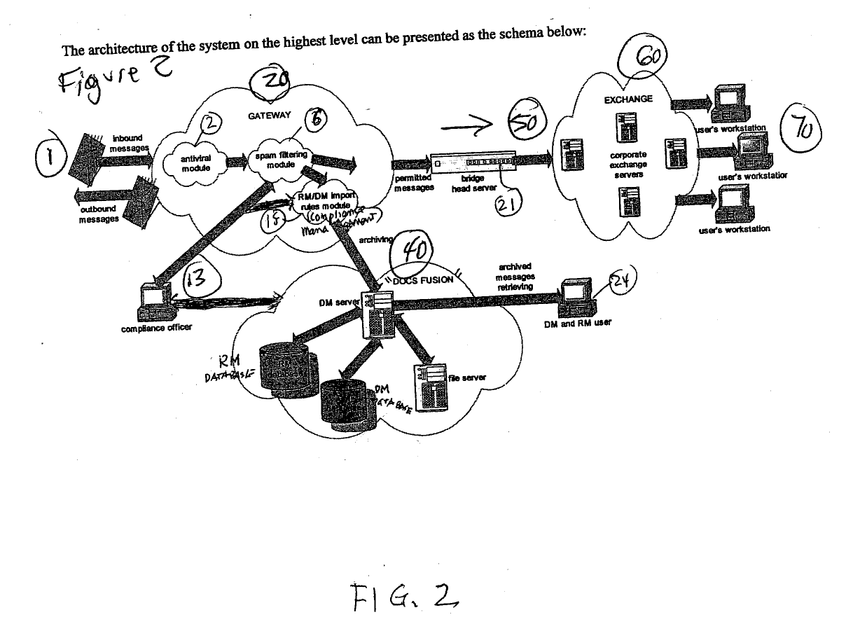

While the broad high-level flowchart of FIG. 1 is intended for overview explanatory purposes, with the detailed and more specific implementations illustrated and later described in connection with FIGS. 2, 4 and 5 particularly, inputs to the various broad functional blocks of FIG. 1 are shown described along the top and bottom edges of the figure, as follows. The virus checker 2 is shown provided with inputs from an antiviral database (DB) of existing viruses and an antiviral module, so-labeled. To the spam filter 6 are applied government and/or industry regulation information inputs at 11 and the outputs from a spam message checked module 61 responsive to input information from regulated documents at 12 and from the compliance review officer at 13, and from a spam sample database 6¹¹ updated by spam samples from the Internet. RMS/DMS inputs to the archive module 8 and the document-reviewing module 8¹ are controlled by RMS/DMS import rules module so labeled at 18. The enterprise or corporation or client exchange at 15 receives the communication message at 17 providing the useful information at 16.

In referring to the “government” and “industry” regulation module 11 of FIG. 1 and elsewhere herein, the term “government” is used generically to embrace, without limitation, all levels of municipal, state and federal and foreign legislative, executive, agency, department, legal, military, enforcement and security entities; “industry”, to embrace, again without limitation, product manufacturers and distributors, and all other types of industrial enterprises; “business”, similarly to embrace all commercial activities, financial, all information and entertainment media, insurance, trading, data providers, service and information providers, health and medical providers, consulting and the like, both private and non-private and not-for-profit organizations; and “academic” to embrace all levels and institutions for teaching, instruction, research and educational activities. In short, the invention appears to be universally applicable to all endeavors which require electronic message integrity and real-time assurance of compliance with pre-established regulations, rules, policies and monitoring requirements—public or private, or both.

Through the scheme of the invention, moreover, the spam filtering management of FIG. 1 thus provides intellectual functionality of the filtering to avoid the “junk” e-mail filling of the RMS. There is, moreover, no need for huge intermediate information storage in view of the novel compliance processing in real time. The inbound communication message at 1 is shown fed to a first diagrammatic gateway cloud 20 containing three components—the antivirus module of FIG. 1, the spam filtering module 6, and a compliance managing module comprising the RM/DM import rules module 18 of FIG. 1. Tied into this compliance management module 18 is the compliance review officer station 13 of FIG. 1. What happens is that the captured or received electronic communication message is split off—the message is sent to the before-described e-mail system heading in the direction of number 50 to the destination user 70, and a copy is made that goes back to an archiving cloud 40 such as, for example, the “DOCSFUSION” system of the before-mentioned “Hummingbird” type—a document management server system including a routing management database RM, a document management database DM, and a file server, so labeled, where the information is stored. The providing of such copy ensures the integrity of the contents that was sent to the user, against any user alteration of the original contents.

Returning to the e-mail path 50, a bridge server 21 is shown provided which passes permitted messages to the e-mail environment labeled 60, such as the before-mentioned “Microsoft Exchange” e-mail system involving corporate exchange servers and ultimate destination user workstations 70, showing how the e-mail is delivered to the destination users.

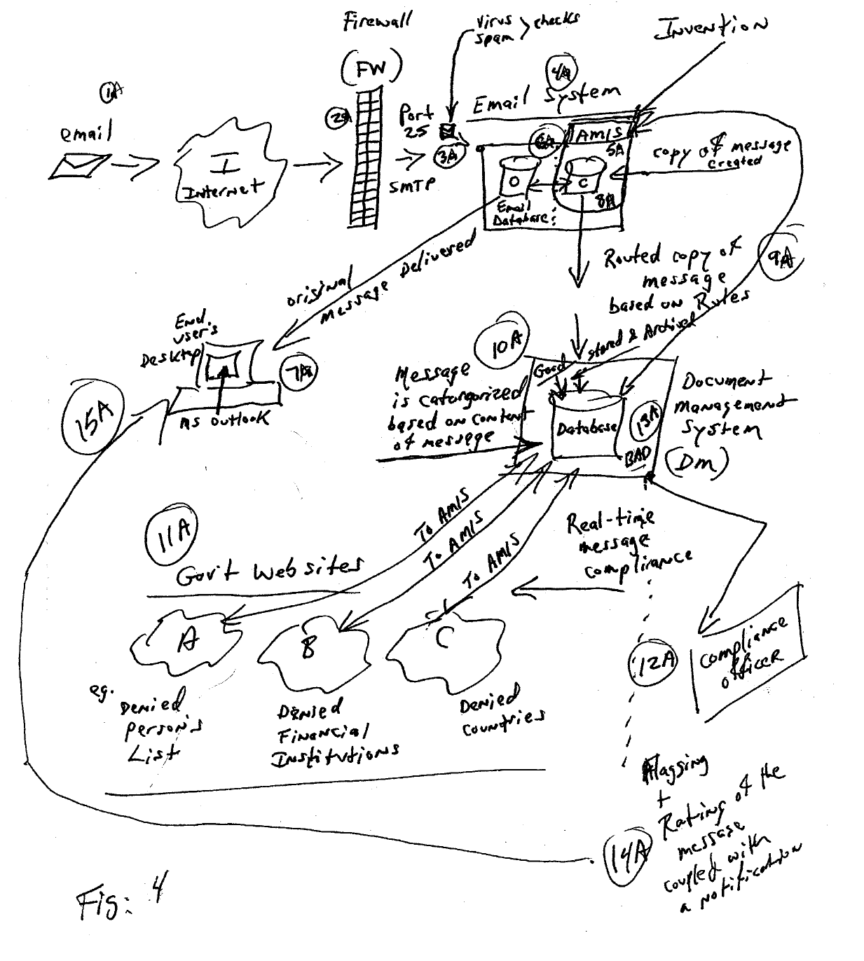

This embodiment of the invention is thus a solution technology that runs as a component or module supplement on to other applications—a tie-in either to an e-mail system, or to a database, or to a document management system. The invention thus provides a core technology component that may be universally hooked in, and that not only will capture and move e-mails and the like to locations, but provides search functions, categorizations, indexing as well as compliance with regulatory rules—all done in real-time, as more fully hereinafter detailed including in the embodiment of FIG. 3.

In FIG. 3, more detail as to the RM/DM import rules-security module operation at 18 is shown, this time positioned outside the gateway cloud 20 of FIG. 2 and to the right, and cooperating with the inputting AMIS compliance e-mail formatting engine 21 and with a real-time compliance module 22. The module 22 accesses, at 11, compliance database files or Internet website information or the like containing government (“Gov't Site”), industry, business, academic and/or other regulatory or pre-established compliance information requirements (“Regulatory Sites”), and including forbidden person or organization or country lists (“Denied Person's Site”). Comparison is made by the real-time compliance module 22 of categorized contents of the e-mail message copy forwarded at 50 and provided by the AMIS compliance engine bridge 21, in terms of such elements ad key words, phrases, subject, attachments, origination destination, etc. and in accordance with the input of the RM/DM import rules/security module 18. In the event that the comparison indicates categorized content to be in conflict with such compliance requirement information, such is flagged at 23 and rated as to severity or importance priority and thereupon forwarded for compliance review by the compliance officer(s) at 13 (“Automated Severity Rating Generated”). Additionally, the destination user of the e-mail message at 70 may be notified, via the dash-line path 23′, of such flagging and/or rating, as for the purposes of self-regulation, over-ride or other informational purposes. In the event, however, that the comparison at the module 22 indicates no problems or conflicts with regulatory compliance, the message communication copy is archived as at 24, for future recovery or retrieval or other use.

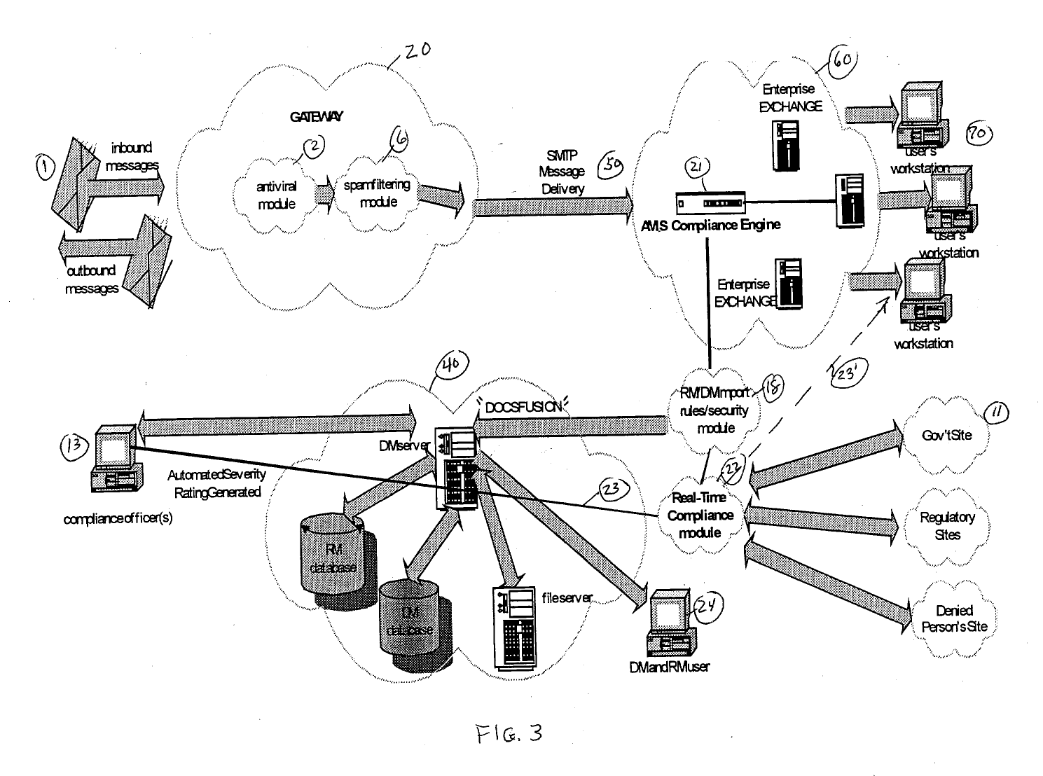

A variant in diagrammatic presentation of the concept of the invention is presented in FIG. 4 which is believed useful to provide a summary review. The e-mail is shown at 1A sent over the Internet I and received at the firewall FW and transported over SMTP (port 25) and is subjected to virus and spam check at 3A (2 and 6 in FIGS. 1-3) and then reaches the e-mail message system 4A (such as the earlier mentioned example of “Lotus Notes” 60 in FIGS. 2 and 3) within which the present invention, termed AMIS (automated message integrity system) is embedded at 5A. A copy of the e-mail is simultaneously made the moment it reaches the e-mail system, as at 6A, and the original goes to the end user destination 7A, (70 in FIGS. 2 and 3) while the copy made in the data base 8A is routed based on rules (basically the contents of the message) at 9A to a document management system DM (such as the earlier mentioned “IntraSpect”, “Hummingbird”, “Documentem” or database “Oracle” and the like—40 in FIGS. 2 and 3). Message categorization based on elements of the contents of the message is effected at 10A and is stored in the database (so-labeled) and compared in real time to government web sites 11A, such as denied person's lists A, denied financial destinations B and denied countries C, as examples. The information in the content of the messages thus compared against these illustrative information web sites (at 22 in FIG. 3) will result in compliance (labeled “Good” at the upper left of the “Database”) and archive storage; or will result in a non-compliance problem (labeled “Bad” at the lower right) in which even this is routed to a compliance officer 12A (13 in FIGS. 1-3), preferably with a severity or category rating indication 14A, and for a hold control or information for the destination or end user 7A as at 15A (23′ in FIG. 3).

The invention thus obviates in large part the growing delays and resulting problems with compliance officers reviewing increasing volumes of stored data to compare against regulatory databases and web site files to see whether or not the message conformed to the regulation requirements—a “post mortem” comparison, with the regulations and rules changing all the time. Where security is at stake, such a lag time to provide the ability to respond to a threat can be serious. The invention, in providing for real-time automatic integrity and compliance checking, admirably solves this problem.

Further modifications will occur to those skilled in this art, and such are considered to fall within the spirit and scope of the invention as defined in the appended claims.

What is claimed is:

1. A method of automatically managing electronic communications such as e-mail so as to enable real-time compliance with government, industry, business, academic and/or other regulatory and other pre-established compliance requirements, the method comprising:
a) receiving the communication, sending the same to its indicated destination user, and also making a copy of the communication to ensure the integrity of the contents that was sent to the user against any user alteration of the contents;
b) categorizing the contents of the copy in terms of such elements as name, keywords, phrases, file attachments, subject, origination and destination;
c) accessing a compliance database file or web site information containing said government, industry, business, academic and/or other regulatory or other pre-established compliance requirement information;
d) comparing the categorized contents with such compliance requirement information in real-time;
e) in the event the comparison indicates no problems, archiving the communication copy for future recovery or retrieval;
f) in the event that the comparison indicates categorized contents to be in conflict with such compliance requirement information, flagging this problem and rating its severity or importance priority; and
g) thereupon forwarding the flag and rating for compliance review.

2. The method of claim 1 wherein the further step is performed of notifying the destination user of said flagging or rating as for self-regulation, over-ride or other informational purposes.

3. The method of doing business in the providing of a new service supplemental to existing electronic document management systems as used by businesses and others, and enabling real-time compliance with government, industry, business, academic and/or other regulatory and other pre-established compliance requirements, the method comprising:
a) supplementing such electronic document management systems as they receive an electronic communication and send the same to its indicated destination user, with the simultaneous making of a copy of the communication to ensure the integrity of the contents that was sent to the user against any user alteration of the contents;
b) categorizing the contents of the copy in terms of such elements as name, subject, keywords, file attachments, phrases, origination and destination;
c) accessing a compliance database file or web site information containing said government, industry, business, academic and/or other regulatory or other pre-established compliance requirement information;
d) comparing the categorized contents with such compliance requirement information in real-time;
e) in the event the comparison indicates no problems, archiving the communication copy for future recovery or retrieval;
f) in the event that the comparison indicates categorized contents to be in conflict with such compliance requirement information, flagging this problem and rating its severity or importance priority; and
g) thereupon forwarding the flag and rating for compliance review, thus imbuing the document management system with the capability of real-time and automatic regulatory compliance.

4. For use with electronic communication document management systems that include existing means for receiving such communications as e-mail and sending the same to indicated destination users, apparatus for automatically managing such electronic communications so as to enable real-time compliance with government, industry, business, academic and/or regulatory and other pre-established compliance requirements, such apparatus having, in combination with the systems:
a) means operable at the time said systems receive such communications and send the same to indicated destination users, for simultaneously making an electronic copy of the communication to ensure the integrity of the contents that was sent to the user against any user alteration of the contents;
b) means for categorizing the contents of the copy in terms of such elements as name, keywords, subject, file attachments, phrases, origination and destination;
c) means for accessing a compliance database file or web site information containing said government, industry, business, academic and/or other regulatory or other pre-established compliance requirement information;
d) means for comparing the categorized contents with such compliance requirement information in real-time;
e) means operable in the event the comparison indicates no problems, for archiving the communication copy for future recovery or retrieval;
f) and means operable in the event that the comparison indicates categorized contents to be in conflict with such compliance requirement information, for flagging this problem and rating its severity.

5. The apparatus claimed in claim 4 wherein means is provided for forwarding the flagging and rating for compliance review.

6. The apparatus of claim 5 wherein means is provided for notifying the destination user of said flagging or rating as for self-regulation, over-ride or other informational purposes.

7. The apparatus of claim 5 wherein said apparatus is provided as a supplemental module for incorporation in said electronic communication document management system.
